(19) United States
(12) Patent Application Publication
(10) Pub. No.: US 2024/0242311 A1
(43) Pub. Date: Jul. 18, 2024

(54) CELL IMAGE ANALYSIS METHOD, NON-TRANSITORY STORAGE MEDIUM, PRODUCTION METHOD FOR INFERENCE MODEL, AND CELL IMAGE ANALYSIS DEVICE

(71) Applicant: CANON KABUSHIKI KAISHA, Tokyo (JP)

(72) Inventors: SHUHEI TOBA, Kanagawa (JP); YOJI YAMAMOTO, Tokyo (JP); HISAFUMI EBISAWA, Tokyo (JP)

(21) Appl. No.: 18/415,343

(22) Filed: Jan. 17, 2024

(30) Foreign Application Priority Data
Jan. 18, 2023 (JP) 2023-006182

(51) Int. Cl. G06T 5/50; G06T 7/62

(52) U.S. Cl. CPC G06T 5/50; G06T 7/62; G06T 2207/10056; G06T 2207/10148; G06T 2207/20224; G06T 2207/30024; G06T 2207/30242

(57) ABSTRACT

The cell image analysis method includes: an image acquisition step of acquiring a plurality of images of a cell captured at a plurality of imaging distances that are different from each other in the bright field; an index information acquisition step of acquiring index information that is information regarding an index for evaluating a difference between the plurality of images acquired in the image acquisition step; an imaging distance determination step of determining such an imaging distance that a rate of a change in the index information with respect to a change in the imaging distance is equal to or less than a predetermined threshold value; a region extraction step of extracting a cell region included in an image captured at the imaging distance determined in the imaging distance determination step; and a region correction step of performing correction on the cell region extracted in the region extraction step.

### BACKGROUND OF THE DISCLOSURE

### Field of the Disclosure

The present disclosure relates to a cell image analysis method, a non-transitory storage medium, a production method for an inference model, and a cell image analysis device.

### Description of the Related Art

In fields of medical care and biochemistry, in order to monitor a growth behavior of a cell subjected to observation, measurement of an area of a cell region by image analysis is often performed. In order to acquire morphological information of a transparent cell and measure an area of the cell, a phase contrast microscope that enables clear observation of a contour of a cell is used in many cases.

However, in general, a phase contrast microscope has a narrow imaging field of view and requires an object lens or a condenser lens. Thus, there is a problem in that a device configuration is expensive.

In response to those problems, in Japanese Patent Application Laid-Open No. 2007-155982 and Japanese Patent No. 6333145, methods of acquiring morphological information of a cell by using defocused images are disclosed. Here, the defocused images are images obtained by bright-field imaging with a position of focus shifted by a small distance in a forward direction or a backward direction along an optical axis direction from a focal point position.

In Japanese Patent Application Laid-Open No. 2007-155982, a difference between two defocused images captured with a position of focus shifted forward and backward relative to a focal point position is taken to generate an image in which a contour of a cell is emphasized. Moreover, acquisition of a more accurate shape of a contour is attempted through application of region correction processing, such as thinning processing and region enlargement processing.

In Japanese Patent No. 6333145, there is shown a method involving determining a position of focus that is to be given at the time of capturing two defocused images with a position of focus shifted forward and backward relative to a focal point position in accordance with a contrast of an image, and then generating two difference images as in Japanese Patent Application Laid-Open No. 2007-155982.

In Japanese Patent Application Laid-Open No. 2007-155982, a position of focus that is to be given at the time of capturing defocused images and parameters for region correction are set in advance. However, an appropriate position of focus for capturing defocused images and an appropriate region correction method may vary depending on a kind, a size, a shape, and the like of a cell. Thus, it is preferred that the position of focus and the parameters for region correction be automatically determined.

Moreover, in Japanese Patent No. 6333145, a position of focus that is to be given at the time of capturing defocused images is determined by using a contrast of an image. However, for the purpose of measuring an area of a cell region as in monitoring of a growth behavior, determination of a position of focus in accordance with a contrast may not be necessarily appropriate. For example, in area measurement for a colony of iPS cells, formation of halos due to agglomeration of cells inside the colony and occurrence of dead cells may affect the contrast. Moreover, in defocused images, a contour of a cell is emphasized, but is blurred due to the capturing with a position of focus shifted relative to a focal point position. Thus, in order to extract an accurate contour, some kind of region correction is required.

Further, in both of Japanese Patent Application Laid-Open No. 2007-155982 and Japanese Patent No. 6333145, extraction of a cell region using two defocused images is attempted. However, in view of simpler processing, it is demanded that a region be able to be extracted from one defocused image.

### SUMMARY OF THE DISCLOSURE

Thus, an object of the present disclosure is to provide a cell image analysis method that enables accurate determination of an area of a cell region in a simple observation in a bright field.

The problems described above can be solved by the present disclosure described below.

According to an aspect of the present disclosure, there is provided a cell image analysis method including: an image acquisition step of acquiring a plurality of images of the cell captured at a plurality of imaging distances that are different from each other in a bright field, the imaging distance being relative distance in imaging a cell using an imaging device between an object subjected to imaging including the cell and a position of focus of an optical system of the imaging device; an index information acquisition step of acquiring index information that is information regarding an index for evaluating a difference between the plurality of images acquired in the image acquisition step; an imaging distance determination step of determining such an imaging distance that a rate of a change in the index information with respect to a change in the imaging distance is equal to or less than a predetermined threshold value; a region extraction step of extracting a cell region included in an image captured at the imaging distance determined in the imaging distance determination step; and a region correction step of performing correction on the cell region extracted in the region extraction step.

Moreover, according to an aspect of the present disclosure, there is provided a cell image analysis method including: an association information acquisition step of acquiring, when a combination of culture information of a cell and imaging conditions of the cell is imaging information, association information associating a plurality of pieces of the imaging information that are different from each other with calibration information; an imaging information acquisition step of acquiring the imaging information for an image subjected to image analysis; and a calibration information determination step of determining calibration information corresponding to the image subjected to image analysis based on the association information and the imaging information acquired in the imaging information acquisition step, wherein the calibration information associated with the imaging information in the association information includes: an imaging distance determined through an image acquisition step, an index information acquisition step, and an imaging distance determination step; and a correction method for a cell region included in the image, wherein the imaging distance is a relative distance in imaging the cell using an imaging device between an object subjected to imaging including the cell and a position of focus of an optical system of the imaging device, wherein the image acquisition step is a step of acquiring a plurality of images of the cell captured at a plurality of the imaging distances that are different from each other in a bright field, wherein the index information acquisition step is a step of acquiring index information that is information regarding an index for evaluating a difference between the plurality of images acquired in the image acquisition step, and wherein the imaging distance determination step is a step of determining, for each of the plurality of images, such an imaging distance that a rate of a change in the index information with respect to a change in the imaging distance is equal to or less than a predetermined threshold value.

Moreover, according to an aspect of the present disclosure, there is provided a cell image analysis method including: an inference model acquisition step of acquiring, when a combination of culture information of a cell and imaging conditions of the cell is imaging information, and when an image of the cell captured with the imaging conditions is a reference image, an inference model that has learned by using a plurality of the reference images that are different from each other in the imaging information and calibration information; and a calibration information determination step of determining calibration information used for image analysis by using the inference model for an image subjected to the image analysis, wherein the calibration information used for learning by the inference model acquired in the inference model acquisition step includes an imaging distance determined through an image acquisition step, an index information acquisition step, and an imaging distance determination step and a correction method for a cell region included in the image, wherein the imaging distance is a relative distance in imaging the cell using an imaging device between an object subjected to imaging including the cell and a position of focus of an optical system of the imaging device, wherein the image acquisition step is a step of acquiring a plurality of images of the cell captured at a plurality of the imaging distances that are different from each other in a bright field, wherein the index information acquisition step is a step of acquiring index information that is information regarding an index for evaluating a difference between the plurality of images acquired in the image acquisition step, and wherein the imaging distance determination step is a step of determining, for each of the plurality of images, such an imaging distance that a rate of a change in the index information with respect to a change in the imaging distance is equal to or less than a predetermined threshold value.

Moreover, according to an aspect of the present disclosure, there is provided a non-transitory storage medium having stored thereon a program for causing a computer to execute the cell image analysis method described above.

Moreover, according to an aspect of the present disclosure, there is provided a production method for an inference model including causing a learning model to learn such that, when a combination of culture information of a cell and imaging conditions of the cell is imaging information and an image of the cell captured with the imaging conditions by using an imaging device in a bright field is a reference image, through use of a plurality of the reference images that are different from each other in the imaging information and calibration information, a similarity with respect to a label corresponding to the calibration information is output when an image subjected to image analysis is input, wherein the calibration information used for learning by the learning model includes an imaging distance determined through an image acquisition step, an index information acquisition step, and an imaging distance determination step and a correction method for a region of the cell included in the image, wherein the imaging distance is a relative distance in imaging the cell using an imaging device between an object subjected to imaging including the cell and a position of focus of an optical system of the imaging device, wherein the image acquisition step is a step of acquiring a plurality of images of the cell captured at a plurality of the imaging distances that are different from each other in a bright field, wherein the index information acquisition step is a step of acquiring index information that is information regarding an index for evaluating a difference between the plurality of images acquired in the image acquisition step, and wherein the imaging distance determination step is a step of determining, for each of the plurality of images, such an imaging distance that a rate of a change in the index information with respect to a change in the imaging distance is equal to or less than a predetermined threshold value.

Moreover, according to an aspect of the present disclosure, there is provided a cell image analysis device including: an image acquisition unit configured to acquire a plurality of images of the cell captured at a plurality of imaging distances that are different from each other in a bright field, the imaging distance being relative distance in imaging a cell using an imaging device between an object subjected to imaging including the cell and a position of focus of an optical system of the imaging device; an index information acquisition unit configured to acquire index information that is information regarding an index for evaluating a difference between the plurality of images acquired by the image acquisition unit; an imaging distance determination unit configured to determine such an imaging distance that a rate of a change in the index information with respect to a change in the imaging distance is equal to or less than a predetermined threshold value; a region extraction unit configured to extract a cell region included in an image captured at the imaging distance determined by the imaging distance determination unit; and a region correction unit configured to perform correction on the cell region extracted by the region extraction unit.

Further features of the present disclosure will become apparent from the following description of exemplary embodiments with reference to the attached drawings.

### BRIEF DESCRIPTION OF THE DRAWINGS

FIG. 1 is a configuration diagram of an information processing system according to a first embodiment.

FIG. 2 is a block diagram for illustrating a hardware configuration of the information processing system according to the first embodiment.

FIG. 3 is a flow chart of a cell image analysis method according to the first embodiment.

FIG. 4 is a conceptual view of setting a rectangular region to defocused images.

FIG. 5 provides an example of rectangular regions cut out from defocused images captured at imaging distances that are different from each other.

FIG. 6 is an illustration providing an example of cell regions extracted from the rectangular regions cut out from the defocused images.

FIG. 7 is a graph for showing an example of results of measuring areas of cell regions extracted from rectangular regions cut out from defocused images captured at a plurality of imaging distances.

FIG. 8 is a graph for showing an example of results obtained by calculating area change rates with respect to the imaging distances.

FIG. 9 is a graph for showing results of comparison of area measurement values given before and after region correction.

FIG. 10 is a configuration diagram of an information processing system according to a second embodiment.

FIG. 11 is a flow chart of a cell image analysis method according to the second embodiment.

FIG. 12 is a configuration diagram of an image processing system according to a modification example of the second embodiment.

FIG. 13 is a flow chart of a cell image analysis method according to the modification example of the second embodiment.

FIG. 14 is a configuration diagram of an information processing system according to a third embodiment.

FIG. 15 is a flow chart of a cell image analysis method according to the third embodiment.

FIG. 16 is an illustration providing an example of pieces of learning information and labels used by an inference model at the time of learning.

FIG. 17 is a configuration diagram of an information processing system according to a modification example of the third embodiment.

FIG. 18 is a flow chart of a cell image analysis method according to the modification example of the third embodiment.

FIG. 19 is a configuration diagram of a learning device in a fourth embodiment.

FIG. 20 is a flow chart of a production method for an inference model according to the fourth embodiment.

FIG. 21 is a view for illustrating an example of defocused images and pieces of calibration information that are stored in a storage unit.

### DESCRIPTION OF THE EMBODIMENTS

Now, exemplary embodiments of the present disclosure are described with reference to the accompanying drawings. In the drawings, the same or corresponding elements are denoted by the same reference symbols, and description thereof may be omitted or simplified. The present disclosure is not limited to the exemplary embodiments and illustrated examples described below.

A defocused image corresponds to image data obtained by bright-field imaging with a relative position between a focal point of an imaging optical system and an object subjected to imaging shifted by a small distance along an optical axis direction of the optical system from a focal point position, and a configuration of the optical system is not limited. For simplicity in the following description, an image captured at the focal point position may also be described as a defocused image with a shift by a distance of 0 from the focal point position. In the present disclosure, a relative distance in imaging a cell using an imaging device between an object subjected to imaging including the cell and a position of focus of an optical system of the imaging device is referred to as “imaging distance.”

### First Embodiment

In a first embodiment, a method of determining, based on a plurality of defocused images, imaging distances for capturing defocused images preferred for extraction of cell regions and a correction method to be applied to the cell regions that have been extracted is described. As a suitable example of determining areas of the cell regions, a cell colony (hereinafter simply referred to as “colony”) formed by stem cells is described as an example. Examples of the stem cells that can be used include an induced pluripotent stem cell (iPS cell) and an embryonic stem cell (ES cell).

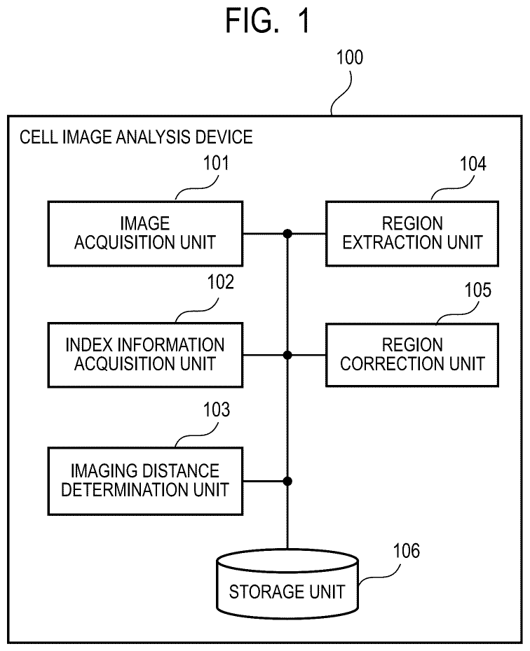

FIG. 1 shows a configuration diagram of an information processing system (cell image analysis device) according to the present embodiment, which is capable of executing a cell image analysis method.

An information processing system 100 includes an image acquisition unit 101, an index information acquisition unit (index-value acquisition unit) 102, an imaging distance determination unit 103, a region extraction unit 104, a region correction unit 105, and a storage unit 106.

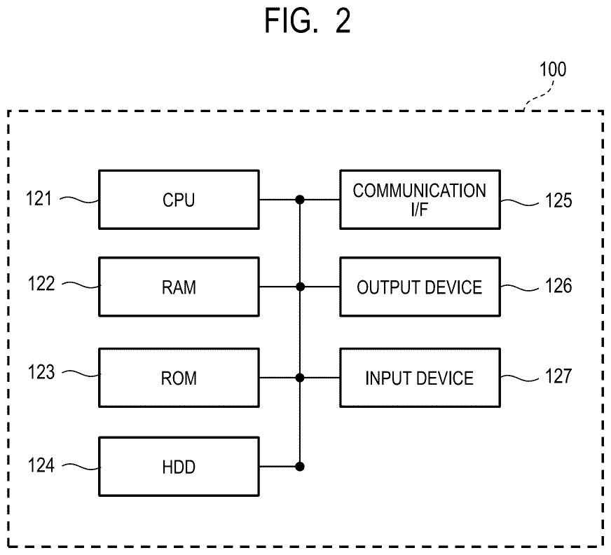

FIG. 2 is a block diagram for illustrating a hardware configuration of the information processing system 100 according to the present embodiment. The information processing system 100 includes a central processing unit (CPU) 121, a random-access memory (RAM) 122, a read-only memory (ROM) 123, a hard disk drive (HDD) 124, a communication interface (I/F) 125, an output device 126, and an input device 127. These units are connected to each other via a bus or the like.

The CPU 121 is a processor that reads programs stored in the ROM 123 and the HDD 124 into the RAM 122 and executes the programs, and performs calculation processing, control of each unit of the information processing system 100, and the like. The processing performed by the CPU 121 may include acquisition of cell images, image processing and analysis for determination of imaging distances, extraction of cell regions, correction processing on the cell regions that have been extracted, and the like.

The RAM 122 is a volatile storage medium and functions as a work memory when the CPU 121 executes a program. The ROM 123 is a non-volatile storage medium, and stores firmware and the like necessary for the operation of the information processing system 100. The HDD 124 is a non-volatile storage medium, and stores image data acquired by the image acquisition unit 101, programs used for the processing by the CPU 121, and the like.

The communication I/F 125 is a communication device based on a standard such as Wi-Fi (registered trademark), Ethernet (registered trademark), or Bluetooth (registered trademark). The communication I/F 125 is used for communication with, for example, the imaging device taking cell images which are acquired by the image acquisition unit 101, or the like.

The input device 127 is a device for inputting information to the information processing system 100, and is typically a user interface for a user to operate the information processing system 100. Examples of the input device 127 include a keyboard, buttons, a mouse, and a touch panel.

The output device 126 is a device in which the information processing system 100 outputs information to the outside, and is typically a user interface for presenting information to the user. Examples of the output device 126 include a display and a speaker.

Note that the configuration of the information processing system 100 described above is merely an example, and can be changed as appropriate. Examples of processors that can be mounted on the information processing system 100 include a Graphics Processing Unit (GPU), an Application Specific Integrated Circuit (ASIC), and a Field Programmable Gate Array (FPGA) in addition to the CPU 121. A plurality of processors may be provided, or a plurality of processors may perform processing in a distributed manner. The function of storing information such as image data in the HDD 124 may be provided not in the information processing system 100 but in another data server. The HDD 124 may be a storage medium such as an optical disk, a magneto-optical disk, or a solid-state drive (SSD).

The CPU 121 executes a program to perform predetermined calculation processing. The CPU 121 controls each unit in the information processing system 100 by executing a program. With the processing described above, the CPU 121 realizes functions of the image acquisition unit 101, the index information acquisition unit 102, the imaging distance determination unit 103, the region extraction unit 104, and the region correction unit 105.

The hardware configuration illustrated in FIG. 2 is an example, and devices other than the illustrated devices may be added, or part of the illustrated devices may be omitted as long as the functions of the information processing system 100 according to the present embodiment are realized. In addition, part of the devices may be substituted with another device having the same function. Further, part of the functions may be provided by another device via a network, and the functions for implementing the embodiments may be shared and implemented by a plurality of devices. For example, the HDD 124 may be substituted with a solid state drive (SSD) using a semiconductor element such as a flash memory.

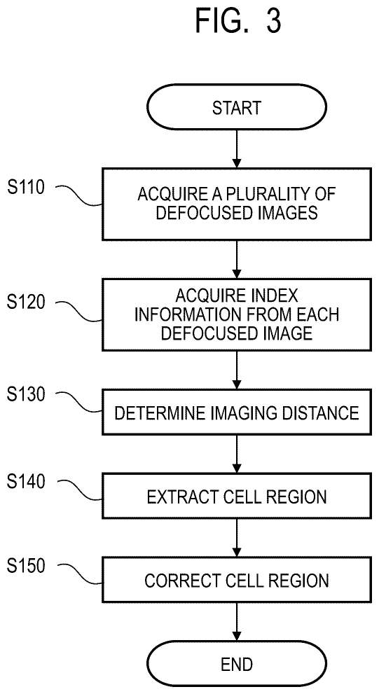

FIG. 3 shows a flow chart of the cell image analysis method according to the first embodiment, which is executed by the information processing system 100.

In an image acquisition step of Step S110, the image acquisition unit 101 acquires a plurality of images (defocused images) of the cell captured at a plurality of imaging distances that are different from each other in a bright field. Here, conditions of the defocused images other than the imaging distances are the same. The conditions include a kind of lens, exposure time, an ISO sensitivity, and a magnification. Moreover, it is preferred that an upper limit value of a range of the imaging distances in the plurality of images acquired by the image acquisition unit 101 be a value that is sufficiently larger than a thickness of a cell subjected to imaging. For example, in the case of the iPS cell colony, the image acquisition unit 101 acquires eleven images captured at intervals of 100 μm within imaging distances of from 0 μm to +1,000 μm. Here, the defocused images captured at the imaging distances of 0 μm, 100 μm, . . . , 1,000 μm are represented by defocused images Z0, Z1, . . . , Zn, . . . , Z10. The defocused image Z0 with an imaging distance of 0 μm is an image captured at the focal point position. The focal point position with an imaging distance of 0 μm in the present embodiment is not required to be a focal point position strictly determined by a configuration of an optical system of the imaging device, and may be, for example, a position that is visually set by a user. In such a case, the user observes a subject cell while changing the imaging distance, and sets a position at which a contour of the cell region is the most unclear to be 0 μm. After being set once, the imaging distance of 0 μm is not required to be changed in subsequent observation. In the present embodiment, an imaging distance in a direction in which an object subjected to imaging and the imaging device separate away from each other is described as being positive, and an imaging distance in a direction in which the object subjected to imaging and the imaging device approach each other is described as being negative.

In an index information acquisition step of Step S120, the index information acquisition unit 102 acquires index information, which is information regarding an index for evaluating a difference between the plurality of images (defocused images) acquired in the image acquisition step of Step S110.

In the present embodiment, an example of a case in which the index information described above is an area of the cell region is described.

In this case, the index information acquisition step includes extracting, by the index information acquisition unit 102, cell regions for the plurality of images acquired in the image acquisition step and measuring areas of the cell regions that have been extracted.

The index information acquisition step may further include setting, by the index information acquisition unit 102, rectangular regions including the cell regions for the plurality of images acquired in the image acquisition step and measuring areas of the cell regions included in the rectangular regions. The rectangular regions set in the index information acquisition step are each such a rectangular region that cut outs a part of an image, and a small region including a cell region is selected. In a case of a cell image obtained by imaging a colony of iPS cells, a region including at least one colony is set as the rectangular region.

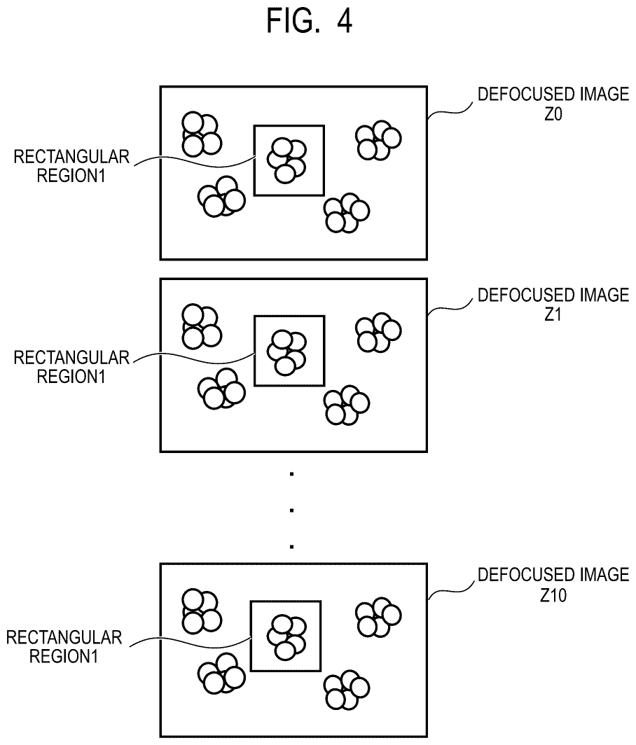

FIG. 4 shows a conceptual view of setting rectangular regions to the defocused images acquired by imaging a colony of iPS cells.

A rectangular region 1 that cut outs a colony is set for each of the defocused images Z0 to Z10 acquired in Step S110. Here, the rectangular region may be suitably set by a user, and a method of setting the rectangular region is not limited to the method of setting by a user. For example, the rectangular region may be set by extracting the cell regions from the defocused images, labeling regions that are not coupled to a periphery, and randomly selecting one of rectangles surrounding the regions.

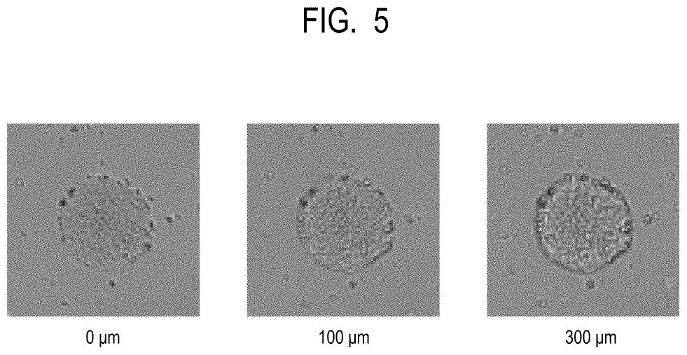

FIG. 5 shows an example of rectangular regions including a colony of iPS cells cut out from defocused images acquired at imaging distances of 0 μm, 100 μm, and 300 μm.

The cell regions in the rectangular regions that have been set can be extracted by image processing through application of a differential filter and binarization processing.

First, a differential image is generated by applying a differential filter to an image. The differential image is obtained by calculating, for each pixel, an amount of change in luminance value between the pixel and surrounding pixels, and expressing calculated amounts of change as an image. In a case of an image including a cell, the differential image is an image that has a large amount of change in luminance value in contour portions of cell regions and contour portions of cells within the cell regions.

Next, regions having high luminance values in the differential image are extracted by performing binarization processing on the differential image. In the binarization processing, any threshold value is set, and a value of each pixel of the differential image is replaced with 1 when the value is equal to or more than the threshold value, and with 0 when the value is less than the threshold value. How the binarization processing is executed is not limited to the method in which any threshold value is set. For example, a method of automatically determining a threshold value such as Otsu's binarization or binarization by Li's algorithm may be used. In a case of setting any threshold value, the threshold value is set so as to suit imaging conditions of the device such as exposure time and focus settings. A method of determining a threshold value for each pixel of an image such as adaptive binarization may also be used. Through the binarization processing, a binary image expressed by setting 1 to pixel values in a region in which the luminance value changes greatly and 0 to pixel values in other regions (hereinafter referred to as “edge image”) is created.

Next, a mask image of cell regions is generated based on the edge image. Here, the mask image is a binary image in which cell regions are expressed by a pixel value of 1 and other regions are expressed by a pixel value of 0. The mask image is generated by extracting regions to which a pixel value of 1 is linked in the edge image, and replacing the pixel values inside each linked region with 1.

The cell region can be extracted for each of the defocused images by applying the processing described above to each of the defocused images acquired in Step S110.

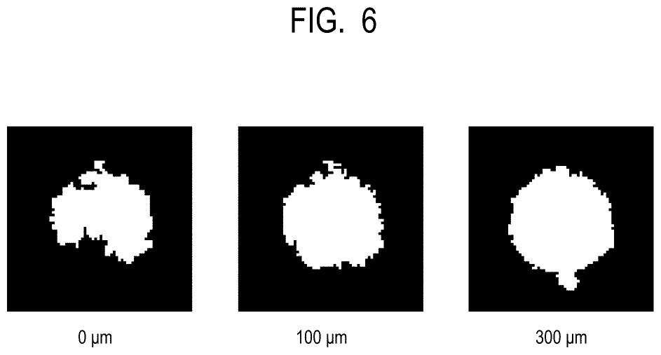

FIG. 6 shows an example in which the cell regions have been extracted from the rectangular regions including the colony of iPS cells shown in FIG. 5, which have been cut out from the defocused images acquired at the imaging distances of 0 μm, 100 μm, and 300 μm.

An area of the cell region can be determined by measurement of counting the number of pixels having a pixel value of 1 in the mask image generated as described above.

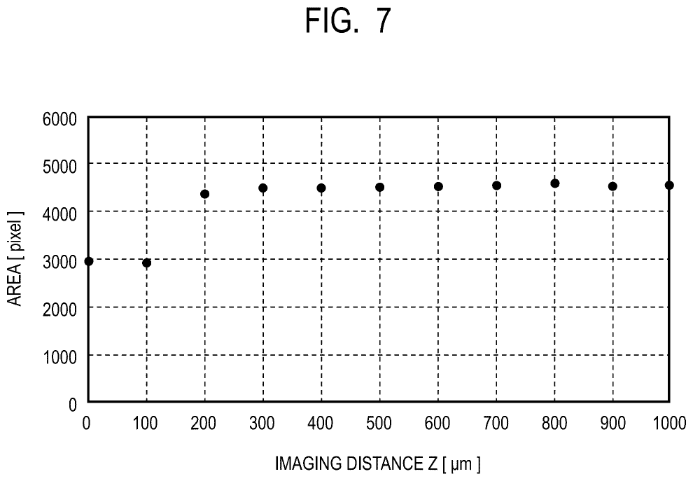

FIG. 7 shows an example of results of measuring areas of the cell regions extracted from the rectangular regions cut out from the defocused images captured at different imaging distances. As shown also in FIG. 6, in a case of the imaging distance close to 0 μm, the contour of the cell region is unclear. Thus, the cell region extracted from the mask image generated as described above is reduced inward as compared to an actual cell region so that a measured area is small. In contrast, when the defocus imaging distance becomes relatively larger, the measured area is stabilized.

Next, in an imaging distance determination step of Step S130, the imaging distance determination unit 103 determines such an imaging distance that a rate of a change in index information with respect to a change in imaging distance is equal to or less than a predetermined threshold value. By the imaging distance determination step of Step S130, an imaging distance for a defocused image that is preferred for application of the processing of extracting a cell region can be determined.

In the present embodiment, such an imaging distance that the rate of the change in area of the cell region determined in the index information acquisition step with respect to the change in imaging distance is equal to or less than the predetermined threshold value is determined. Specifically, for example, with regard to an area change rate Dn with respect to the imaging distance Zn, it is only required that an inclination of a straight line obtained by linear approximation through least squares approximation be calculated by using the area measured for the defocused image captured at the imaging distances within the predetermined range above and below the imaging distance Zn. For example, the area change rate Dn is calculated by using the areas given at three points including the defocused images Zn−1, Zn, and Zn+1 captured within the range of =100 μm with respect to Zn.

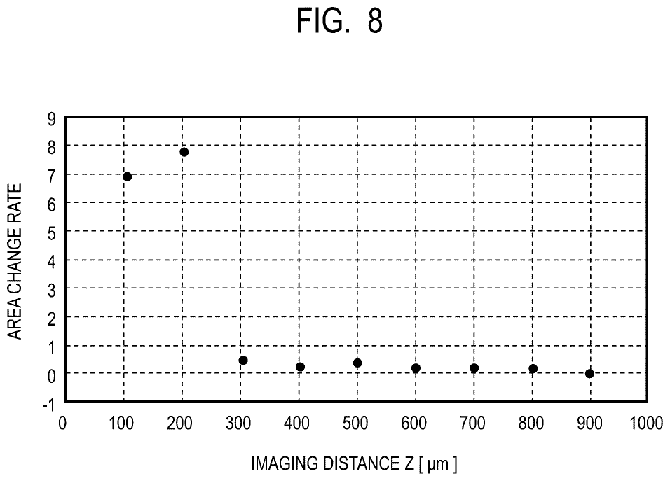

FIG. 8 shows an example of results obtained by calculating area change rates with respect to the measurement results of areas shown in FIG. 7. In the example shown in FIG. 8, the area change rates Dn are determined with an inclination of the straight line obtained by linear approximation through least squares approximation by using the areas at three points including the defocused images Zn−1, Zn, and Zn+1 captured within the range of ±100 μm with respect to Zn.

The predetermined threshold value for determination of the imaging distances is set to, for example, 1.0. In the case of the example shown in FIG. 8, at the imaging distances equal to or more than 300 μm, the threshold value equal to or less than 1.0 is satisfied. Here, in general, as the position of focus given at the time of capturing an image is shifted larger from the focal point position, blurring that occurs in the image also becomes larger. Thus, in view of decreasing the blurring that occurs due to the shift of the position of focus, it is preferred that an absolute value of the imaging distance of the defocused image for extraction of an accurate cell region be smaller. Thus, in the example shown in FIG. 8, among the imaging distances satisfying the threshold value equal to or less than 1.0 described above, the imaging distance of 300 μm, which is the smallest value, can be determined as the defocus imaging distance.

A method of determining the area change rate Dn with respect to the imaging distance Zn is not limited to the method of the example described above. For example, data used for linear approximation are not limited to the three points including Zn and one point above and below Zn, and may be two points including Zn and Zn+1 or five points including Zn and two points above and below Zn. Moreover, for example, the area change rate Dn may be determined by performing curve approximation as described later in Modification Example 3 and using an inclination of a tangential line at Zn of a curve that has been obtained, rather than using the inclination of the straight line obtained by the linear approximation through the least squares approximation.

Next, in a region extraction step of Step S140, the region extraction unit 104 extracts cell regions included in the images (defocused images) captured at the imaging distances determined in the imaging distance determination step.

Methods of extracting the cell regions in the region extraction step include a method of applying the image processing through application of the differential filter and binarization processing used for extracting the cell regions in the index information acquisition step to the defocused image. That is, in the present embodiment, the cell regions extracted in the index information acquisition step for the defocused images captured at the imaging distances determined in the imaging distance determination step may be used as the cell regions to be extracted in the region extraction step.

Next, in a region correction step of Step S150, the region correction unit 105 performs correction on the cell regions extracted in the region extraction step of Step S140.

The region correction step may include determining, by the region correction unit 105, a correction method to be used for the correction of the cell regions. Here, the correction method to be used for the correction of the cell regions corresponds to a method of image processing for implementing the region correction and parameters related thereto.

A rough contour of the cell region can be extracted by applying the image processing through application of the differential filter and binarization processing to the defocused image as described above. However, the defocused image is captured with a shift from the focal point position, with the result that the blurring occurs in the image. Thus, the region correction processing is required for measuring an area of the cell region more accurately.

In the region correction step, the region correction unit 105 can determine the correction method by selecting from, for example, contraction processing, a level-set method, and an active contour method.

For a cell region having an arc-like smooth shape as in an image of a colony of iPS cells, the region can be corrected by the contraction processing of contracting the cell region extracted in Step S140 by the amount corresponding to several pixels from an outer side.

Parameters as to, for example, the amount corresponding to the number of pixels to be reduced in the contraction processing may be determined based on, for example, a defocused image for calibration. Here, the defocused image for calibration is, for example, an image obtained by capturing a dot pattern with a known size. That is, the number of pixels to be contracted in the contraction processing given in this case is the number of pixels determined based on images obtained by capturing dot patterns at the plurality of imaging distances that are different from each other.

As a specific procedure, images obtained by capturing dot patterns at a plurality of imaging distances that are different from each other are acquired as in Step S110, and determination of the region related to the dot patterns and area measurement are performed as in Step S120. The size of the dot pattern is known, and hence the parameters related to the region correction can be determined uniquely by searching for parameters of the contraction processing at the defocus imaging distances so as to match the actual size of the dot pattern.

In the region correction step, the cell region extracted in Step S140 may be corrected by a method of repeatedly optimizing the region such as the level-set method or the active contour method. In general, the method that involves repeated attempts requires much calculation time. However, such method can be implemented with fewer times of repetition by using contour information obtained from the mask image generated in Step S120 as an initial value. The level-set method and the active contour method are effective in such a case in which the cell has a complicated shape.

In Step S150, the region correction unit may determine the correction method based on an index that expresses the complexity of the shape of the cell region, for example, at least one of a circularity or a solidity of the cell region. The circularity C is calculated with Equation (1) by using an area S and a circumferential length L of the cell region extracted in Step S140.

$$C = 4 π S / {L}^{2} \qquad ( 1 )$$

The circularity is a numerical value that indicates the closeness of the region to a true circle and falls within the range of from 0.0 to 1.0. The correction method can be determined based on the circularity C. For example, when the circularity C is equal to or more than 0.8, the region correction through the contraction processing is implemented, and when the circularity C is less than 0.8, the region correction through the level-set method or the active contour method is implemented.

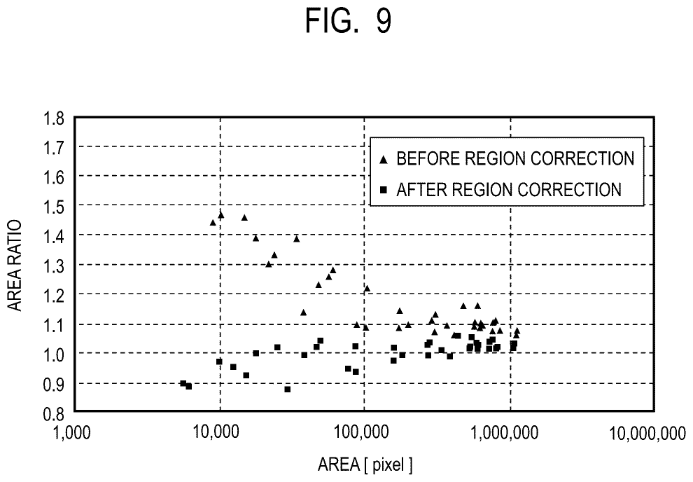

Now, with reference to FIG. 9, an effect of the region correction in the present embodiment is described.

FIG. 9 is a graph for showing results of comparison of area measurement values given before and after extracting a colony of iPS cells as the cell region, measuring an area thereof, and implementing the region correction processing. The horizontal axis represents an area of the colony before and after implementing the region correction in the present embodiment. The vertical axis represents a value obtained by measuring an area of the same colony with another device (IncuCyte device manufactured by Sartorius AG) and calculating a ratio of areas given before and after the implementation of the region correction in the present embodiment with respect to the measurement value that has been obtained. The captured image acquired with the IncuCyte device is obtained by synthesizing a plurality of images, and the blurring due to the defocus imaging does not occur. Thus, an area of the cell region closer to a true value is measured. Thus, as the ratio is closer to 1.0, the area determined according to the present embodiment has a value close to the true value. As shown in FIG. 9, the ratio is close to 1.0 due to implementation of the region correction, and hence the effect of the region correction can be confirmed.

In the above, the method of determining the imaging distances for extracting a more accurate cell region by using a plurality of defocused images and the region correction method has been described. The present embodiment can be utilized effectively in area measurement for the cell region in adherent culture, as in area measurement for a colony in culture of iPS cells.

According to the present embodiment, a more accurate area of a cell region can be determined by region correction while determining imaging distances for acquiring defocused images that are preferred for extraction of the cell region. Further, as described above with reference to FIG. 9, through the region extraction processing and the region correction processing on one defocused image, area measurement for a cell region can be implemented with accuracy equivalent to that given when a synthesized image based on a plurality of images by the IncuCyte device is implemented.

### Modification Example 1 of First Embodiment

The example in which the defocused images are captured at intervals of 100 μm from 0 μm to 1,000 μm in Step S110 of the present embodiment has been described. However, the interval for capturing defocused images may be determined dynamically. For example, the defocused images are captured at intervals of 20 μm from 0 μm to 200 μm, where a contour of a cell is clarified gradually, and are captured at intervals of 100 μm therebeyond. The processing steps subsequent to Step S120 are the same as those of the first embodiment.

Moreover, in relation to FIG. 7 and FIG. 8, the example in which the defocused images captured with imaging distances shifted in the positive direction are used has been described. However, defocused images captured with imaging distances shifted in the negative direction may also be used. When the defocused images are captured with imaging distances shifted in the negative direction, the imaging distances for acquiring the defocused images are set, for example, at the intervals of −100 μm from 0 μm to −1,000 μm. The processing steps subsequent to Step S120 are the same as those of the first embodiment.

### Modification Example 2 of First Embodiment

The index information acquisition step of Step S120 may include setting two or more rectangular regions that are different from each other for each of the plurality of images acquired in the image acquisition step. In this case, the imaging distance can be determined for each rectangular region in Step S130. In this manner, a plurality of candidates can be obtained with regard to an imaging distance of a defocused image suitable for application of the processing of extracting the cell region. Thus, the index information acquisition step of Step S120 may include calculating at least one value selected from a mean value, a median value, and a mode value of the imaging distances determined for two or more rectangular regions. That is, the imaging distance of the defocused image to be used for steps subsequent to Step S140 can be determined by calculating at least one value selected from the mean value, the median value, and the mode value.

### Modification Example 3 of First Embodiment

In the index information acquisition step of Step S120, the index information acquisition unit 102 may acquire an index related to a brightness distribution (histogram) of the defocused image as index information. Moreover, indices related to the brightness distribution include a contrast and a kurtosis. In this case, in the imaging distance determination step of Step S130, the imaging distance determination unit 103 determines an imaging distance of the defocused image that is preferred for application of the processing of extracting the cell region, based on a change in the index related to the brightness information with respect to a change in imaging distance.

Moreover, in the first embodiment, the method of determining an imaging distance of a defocused image by using an area of a cell region has been described. However, calculation of an area change rate may be performed after curve approximation of the data shown in FIG. 7. In such a case, in Step S110, it is preferred that a plurality of defocused images be acquired at imaging distances at narrower intervals.

### Second Embodiment

In the first embodiment, the method of determining imaging distances of defocused images for extracting a cell region by using a plurality of defocused images and the correction method for the cell region have been described. In a second embodiment, a method of determining imaging distances of defocused images and a correction method for a cell region based on culture information and imaging conditions is described. In the following description, information collectively including the imaging distances of the defocused images and the correction method applied to the cell region included in the defocused images determined according to the first embodiment is referred to as “calibration information.”

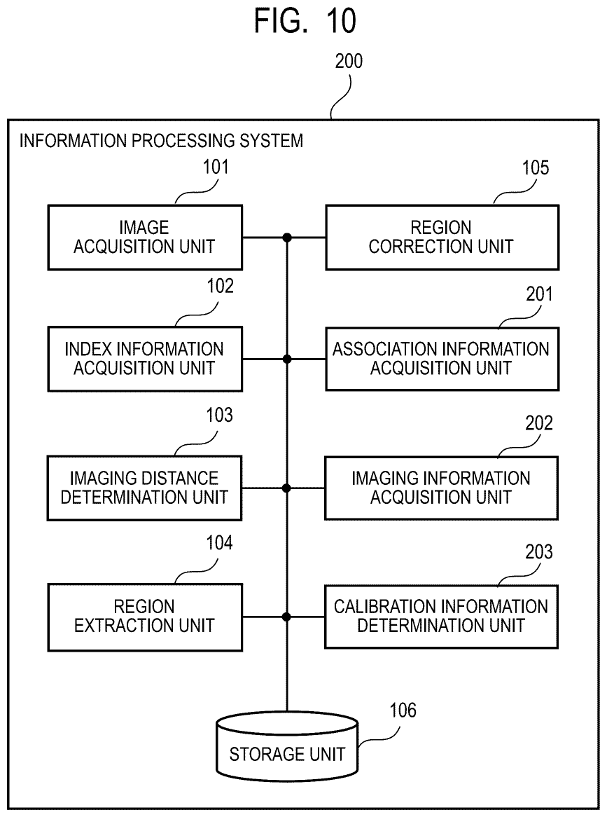

FIG. 10 shows a configuration diagram of an information processing system (cell image analysis device) that is capable of executing a cell image analysis method according to the present embodiment.

An information processing system 200 according to the present embodiment further includes an association information acquisition unit 201, an imaging information acquisition unit 202, and a calibration information determination unit 203, in addition to constituent elements which are the same as those of the information processing system 100 according to the first embodiment. Functions of the association information acquisition unit 201, the imaging information acquisition unit 202, and the calibration information determination unit 203 can be realized, for example, by the CPU 121 provided in the hardware configuration illustrated in FIG. 2.

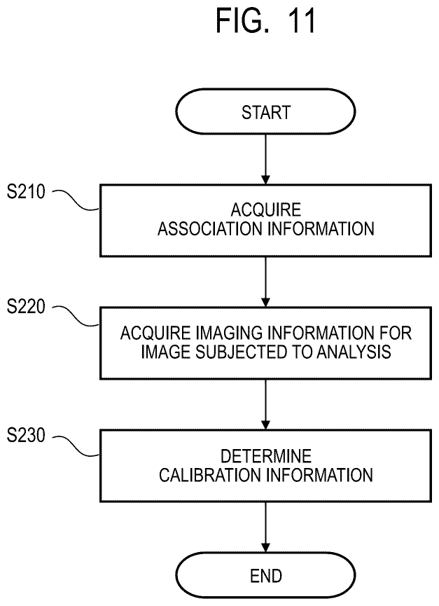

FIG. 11 shows a flow chart of a cell image analysis method according to the second embodiment executed by the information processing system 200.

In an association information acquisition step of Step S210, the association information acquisition unit 201 acquires association information associating a plurality of pieces of imaging information that are different from each other and calibration information. Here, a combination of culture information of a cell and imaging conditions of the cell is imaging information. The culture information is information related to a cell subjected to imaging, and includes items such as a kind of cell and the number of days of culture. Moreover, the imaging conditions include items such as a kind of lens, exposure time, an ISO sensitivity, and a magnification. These are an example of conditions which may affect the imaging distance of the defocused image and the correction method for the cell region that are preferred for extraction of the cell region as determined in the first embodiment. For example, with regard to the culture information of a cell, in a case of a colony of iPS cells, the colony includes a large number of cells each being small and having an irregular shape in an initial stage of culture, whereas the colony includes a larger number of cells each having a substantially circular and smooth shape as the culture proceeds. Moreover, with regard to the imaging conditions, a degree of blurring that occurs in the defocusing varies depending on the difference in exposure time and magnification. It is preferred that the imaging distance of the defocused image and the correction method for the cell region be determined depending on a change in shape of a cell and a degree of blurring as described above.

The association information acquired by the association information acquisition unit 201 is information associating the calibration information determined by the method described in the first embodiment with respect to a plurality of defocused images having pieces of imaging information that are different from each other with the imaging information of the plurality of defocused images.

The calibration information of the association information described above can be determined in advance according to the first embodiment by the image acquisition unit 101, the index information acquisition unit 102, the imaging distance determination unit 103, the region extraction unit 104, and the region correction unit 105, which are included in the information processing system 200.

Alternatively, the calibration information of the association information described above may be determined in advance by using a device corresponding to the information processing system 100 according to the first embodiment, which is different from the information processing system 200. In this case, it is not required that the information processing system 200 include the image acquisition unit 101, the index information acquisition unit 102, the imaging distance determination unit 103, the region extraction unit 104, and the region correction unit 105.

In the association information acquisition step of Step S210, the association information is acquired, which is prepared in advance to associate the calibration information determined in advance as described above and the imaging information.

Next, in an imaging information acquisition step of Step S220, the imaging information acquisition unit 202 acquires imaging information regarding an image subjected to image analysis.

The imaging information regarding the image subjected to image analysis may be input by a user or acquired from additional data recorded in association with the image. Alternatively, when such pieces of information are recorded in a database storing data of the imaging device, the data may be read out from the database. The imaging information is stored as table information associating names of the above-mentioned items and character strings or numerical values representing the respective items.

The association information acquisition step of Step S210 and the imaging information acquisition step of Step S220 are not in particular order, and hence the association information acquisition step of Step S210 may be performed after the imaging information acquisition step of Step S220.

Next, in a calibration information determination step of Step S230, the calibration information determination unit 203 determines calibration information associated with an image subjected to the image analysis based on the association information and the imaging information acquired in the imaging information acquisition step.

In the manner described above, according to the present embodiment, in the bright-field imaging of a sample including a cell, an imaging distance for acquiring a defocused image preferred for the cell region extraction and a correction method for measuring an area of an accurate cell region can be determined in a simple manner.

According to the present embodiment, for example, when the cell region has been determined according to the first embodiment with the same imaging conditions with respect to the same kind of cell in the past, the imaging distance of the defocused image and the correction method for the cell region can be efficiently determined.

In the above, the method of determining the imaging distance of the defocused image and the correction method for the cell region in accordance with the culture information and the imaging conditions has been described.

### Modification Example 1 of Second Embodiment

The second embodiment can be suitably implemented in combination with the first embodiment.

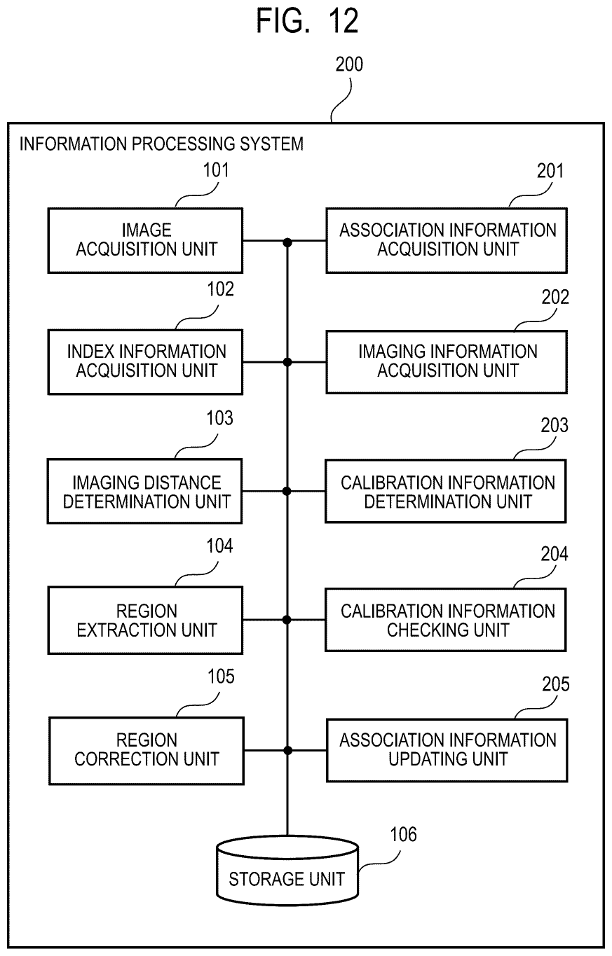

FIG. 12 shows a configuration diagram of an information processing system (cell image analysis device) that is capable of executing a cell image analysis method according to Modification Example 1 of the second embodiment.

In Modification Example 1 of the second embodiment, the information processing system 200 further includes a calibration information checking unit 204 and an association information updating unit 205, in addition to the constituent elements of the second embodiment. Functions of the calibration information checking unit 204 and the association information updating unit 205 can be realized, for example, by the CPU 121 provided in the hardware configuration illustrated in FIG. 2.

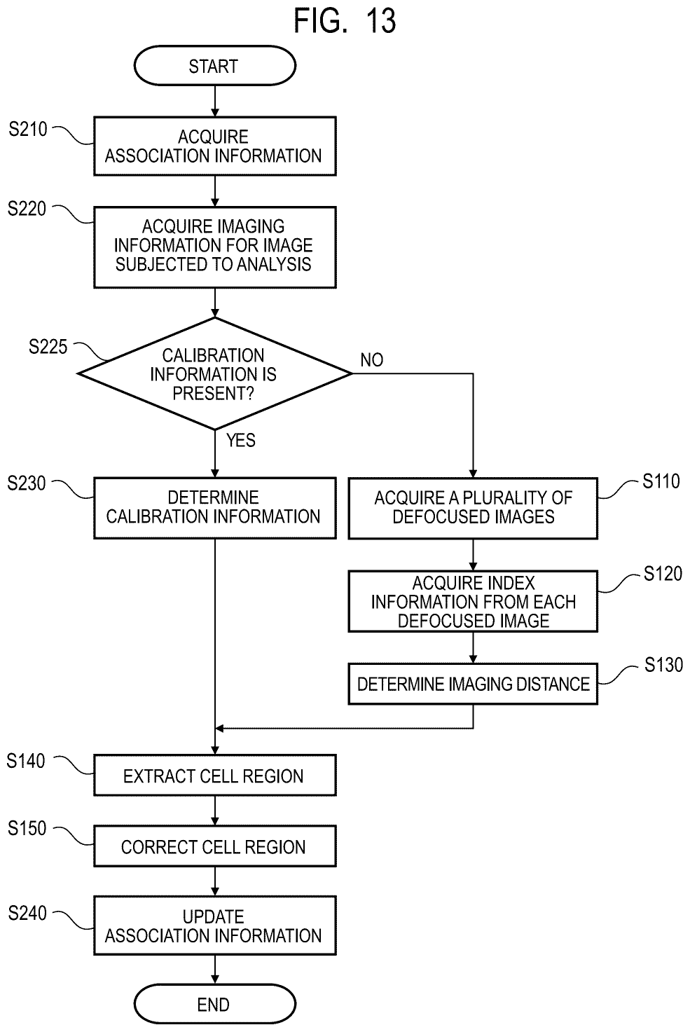

FIG. 13 shows a flow chart of a cell image analysis method according to Modification Example 1 of the second embodiment executed by the information processing system 200.

Contents of the steps of Step S210 and Step S220 are the same as those described in the second embodiment, and hence description thereof is omitted.

Next, in a calibration information checking step of Step S225, the calibration information checking unit 204 checks whether or not the calibration information is present while being included in the association information acquired in Step S210. The calibration information that is checked as to whether or not the calibration information is present while being included is calibration information associated with the culture information acquired in Step S210. When the associated calibration information is not present, the process proceeds to Step S110. When the associated calibration information is present, the process proceeds to Step S230.

Contents of Step S110 to Step S150 are the same as those described in the first embodiment, and hence description thereof is omitted. When the process proceeds from Step S230 to Step S140, the processing steps of Step S140 and Step S150 are executed by using the imaging distance and the correction method based on the calibration information determined in Step S230.

Next, in an association information updating step of Step S240, the association information updating unit 205 updates the association information by associating the imaging distance determined in Step S130 and the correction method used in Step S150 with the imaging information acquired in Step S220.

In Modification Example 1 of the second embodiment, the information processing system 200 is not required to include the association information updating unit 205, and thus is not required to perform the processing of updating the association information in the association information updating step in Step S240.

### Third Embodiment

In the second embodiment, the method of determining the imaging distance of the defocused image and the correction method for the cell region in accordance with the imaging information by associating the imaging information with the imaging distance of the defocused image and the correction method for the cell region as table information has been described.

In a third embodiment, a method of determining the imaging distance of the defocused image and the correction method for the cell region by using an inference model generated based on the defocused image captured in the past and the calibration information is described.

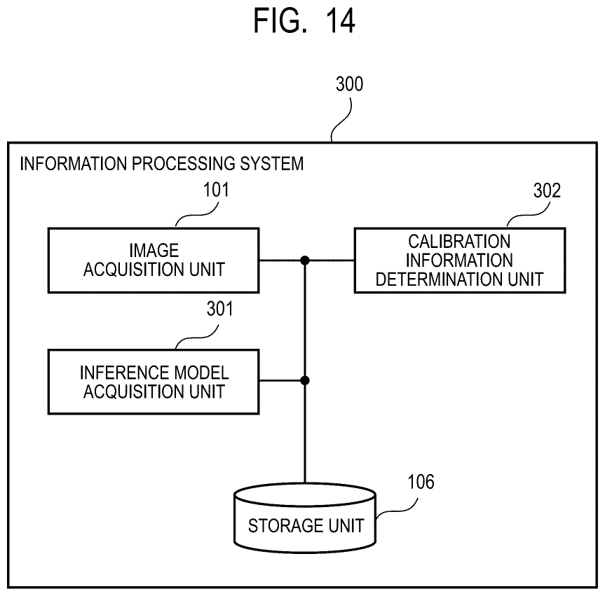

FIG. 14 shows a configuration diagram of an information processing system that is capable of executing a cell image analysis method according to the present embodiment.

An information processing system 300 according to the present embodiment includes the image acquisition unit 101, an inference model acquisition unit 301, and a calibration information determination unit 302. Functions of the image acquisition unit 101, the inference model acquisition unit 301, and the calibration information determination unit 302 can be realized, for example, by the CPU 121 provided in the hardware configuration illustrated in FIG. 2.

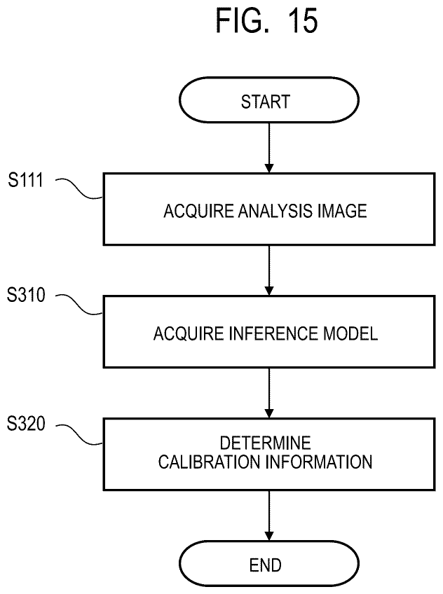

FIG. 15 shows a flow chart of a cell image analysis method according to the third embodiment executed by the information processing system 300.

First, in an analysis image acquisition step of Step S111, the image acquisition unit 101 acquires a defocused image captured at a freely-selected imaging distance. Here, the freely-selected imaging distance is only required to be an imaging distance at which the contour of the cell region can be visually checked, and may be determined by a user or automatically determined by the system. When the freely-selected imaging distance is determined by the system, for example, when the storage unit 106 stores a plurality of pieces of calibration information used for learning by an inference model described later, information of the imaging distance may be acquired from the plurality of pieces of calibration information and a mean value thereof may be used as the imaging distance.

Next, in an inference model acquisition step of Step S310, the inference model acquisition unit 301 acquires an inference model that has learned by using a combination of a plurality of reference images having pieces of imaging information different from each other and the calibration information as learning information. Here, the reference images are images of a cell captured by using an imaging device in a bright field with the imaging conditions included in each piece of imaging information. Moreover, the calibration information included in the learning information used by the inference model for learning includes the imaging distance determined by the method described in the first embodiment and the correction method for the cell region included in the image.

The inference model handled in the present embodiment is an image classification model that performs learning based on ground truth information (hereinafter referred to as “label”) given to the reference images at the time of learning and infers to which label the input image belongs at the time of inference. In the present embodiment, the calibration information is handled as a label.

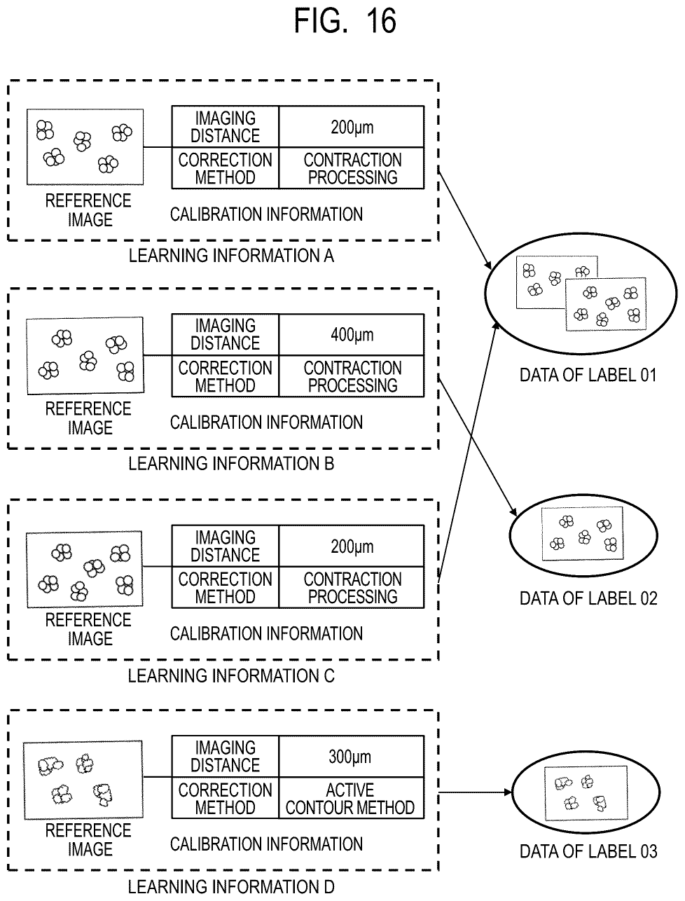

FIG. 16 shows an example of pieces of learning information and labels used by the inference model at the time of learning. In the case of the example illustrated in FIG. 16, the learning information A and the learning information C have the same calibration information. Thus, groups of respective reference images (defocused images) are data having the same label 01. Here, the label 01 corresponds to the calibration information including a combination of an imaging distance of 200 μm and contraction processing being the correction method.

The analysis image acquisition step of Step S111 and the inference model acquisition step of Step S310 are not in particular order, and hence the processing of the analysis image acquisition step of Step S111 may be performed after the inference model acquisition step of Step S310.

Next, in a calibration information determination step of Step S320, the calibration information determination unit 302 determines the calibration information used for image analysis by using the inference model acquired in Step S310 with respect to the image acquired in Step S111.

In the calibration information determination step, the inference model infers to which label the defocused image of the input acquired in Step S111 belongs. Based on the acquired result of inference, the calibration information used for the image analysis can be determined.

The inference model may be configured to infer to which label the defocused image of the input belongs by calculating the similarity between the defocused image of the input and the label. In this case, for example, in the calibration information determination step, the calibration information corresponding to a label having the highest similarity can be determined as the calibration information used for the image analysis.

In the above, the method of determining the imaging distance of the defocused image and the correction method of the cell region using the inference model generated based on the defocused image captured in the past has been described.

According to the present embodiment, for example, when the cell region has been determined according to the first embodiment with the same imaging conditions with respect to the same kind of cell in the past, appropriate calibration information can be determined in accordance with a result of inference of the input defocused image.

### Modification Example 1 of Third Embodiment

The third embodiment can also be implemented suitably in combination with the first embodiment.

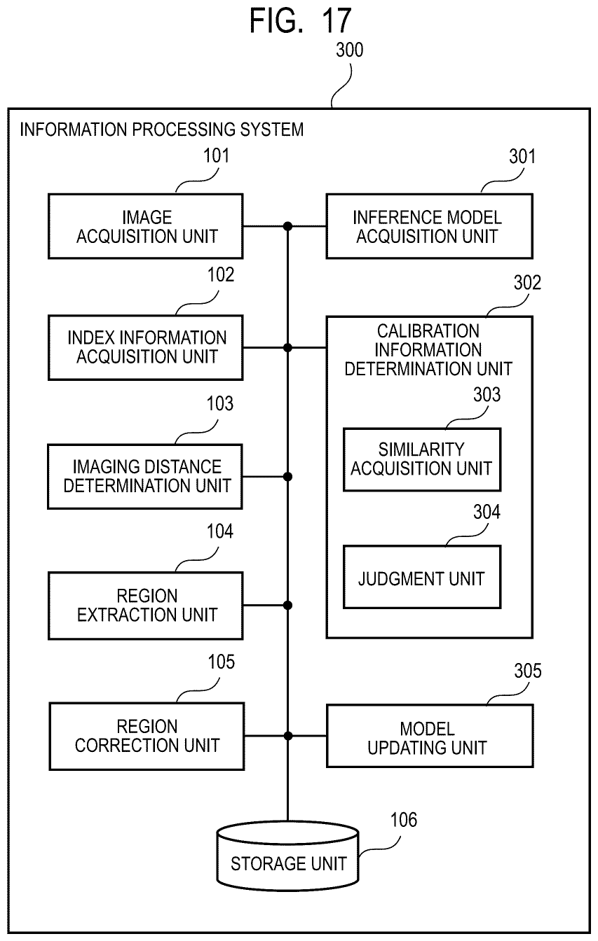

FIG. 17 shows a configuration diagram of an information processing system (cell image analysis device) that is capable of executing a cell image analysis method according to Modification Example 1 of the third embodiment.

In Modification Example 1 of the third embodiment, the information processing system 300 includes, in the constituent elements of the third embodiment, the calibration information determination unit 302 including a similarity acquisition unit 303 and a judgment unit 304. Moreover, the information processing system 300 includes the index information acquisition unit 102, the imaging distance determination unit 103, the region extraction unit 104, and the region correction unit 105 as the same configuration as those of the first embodiment, and further includes a model updating unit 305. Functions of the similarity acquisition unit 303, the judgment unit 304, and the model updating unit 305 can be realized, for example, by the CPU 121 provided in the hardware configuration illustrated in FIG. 2.

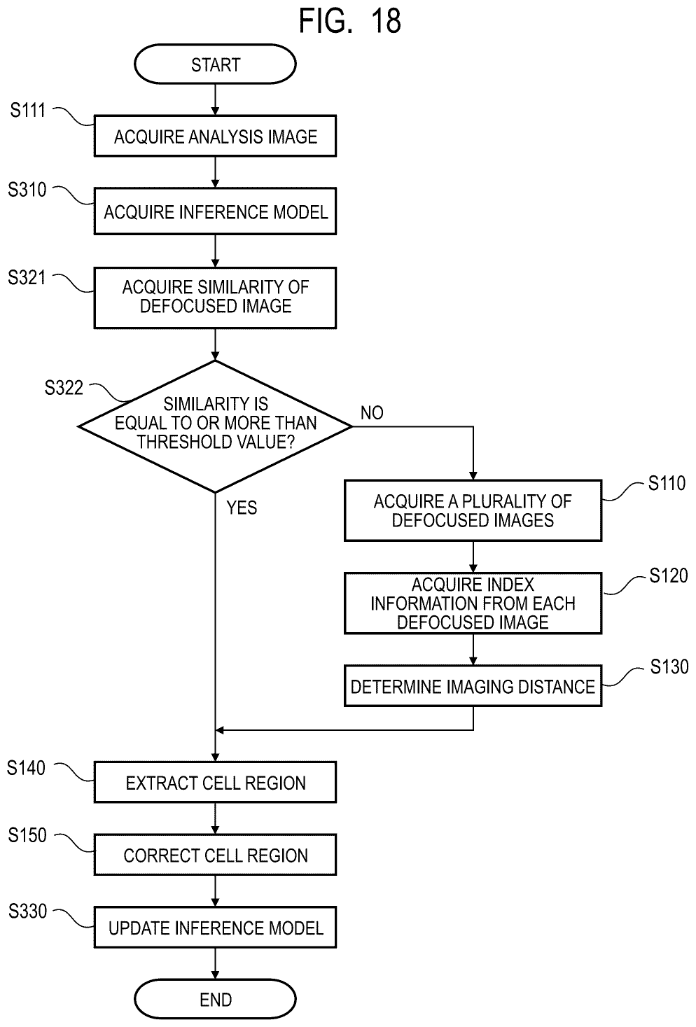

FIG. 18 shows a flow chart of a cell image analysis method according to Modification Example 1 of the third embodiment executed by the information processing system 300.

Contents of the steps of Step S111 and Step S310 are the same as those described in the third embodiment, and hence description thereof is omitted.

Next, in a similarity acquisition step of Step S321, the similarity acquisition unit 303 included in the calibration information determination unit 302 acquires a similarity corresponding to a probability indicating to which label associated with the calibration information the defocused image of the input belongs.

In the inference model for image classification, the probability that the defocused image of the input belongs to each label is output to the inference model. For example, with respect to labels 01 to 03 of three types in the example illustrated in FIG. 16, the probability of belonging to the respective labels is calculated as, for example, 0.8, 0.1, and 0.1.

The inference model judges that the label having the maximum probability among the calculated labels is a label of an input image. In the present embodiment, the maximum probability is handled as the similarity.

Next, in Step S322, the judgment unit 304 included in the calibration information determination unit 302 judges whether or not the similarity calculated in Step S321 is equal to or more than a predetermined threshold value. The threshold value is set, for example, as 0.8. The threshold value is a measure indicating whether or not the inference model can perform inference with high accuracy, and it is preferred that a value larger than an inverse of the total number of labels to be inferred be set as the threshold value.

When the similarity is equal to or more than the predetermined threshold value, the process proceeds to Step S140. When the similarity is less than the threshold value, the process proceeds to Step S110.

First, a case in which the similarity is less than the threshold value is described.

Contents of Step S110 to Step S130 are the same as those described in the first embodiment, and hence description thereof is omitted. That is, in Modification Example 1 of the third embodiment, the calibration information determination step includes determining, when the similarity is less than the predetermined threshold value, an imaging distance by the method described in the first embodiment for an image subjected to image analysis.

When the similarity is equal to or more than the predetermined threshold value, the processing steps subsequent to Step S140 are performed in accordance with the calibration information corresponding to a label indicating the highest similarity. Contents of Step S140 and Step S150 are the same as those described in the first embodiment, and hence description thereof is omitted.

Next, in a model updating step of Step S330, the model updating unit 305 updates the inference model by using the imaging distance determined in Step S130 and the correction method used in Step S150 as the ground truth information of the defocused image of the imaging distance determined in Step S130.

In Modification Example 1 of the third embodiment, the information processing system 300 is not required to include the model updating unit 305, and thus is not required to perform the processing of updating the inference model in the model updating step of Step S330.

### Fourth Embodiment

In a fourth embodiment, a production method for the inference model used in the third embodiment is described.

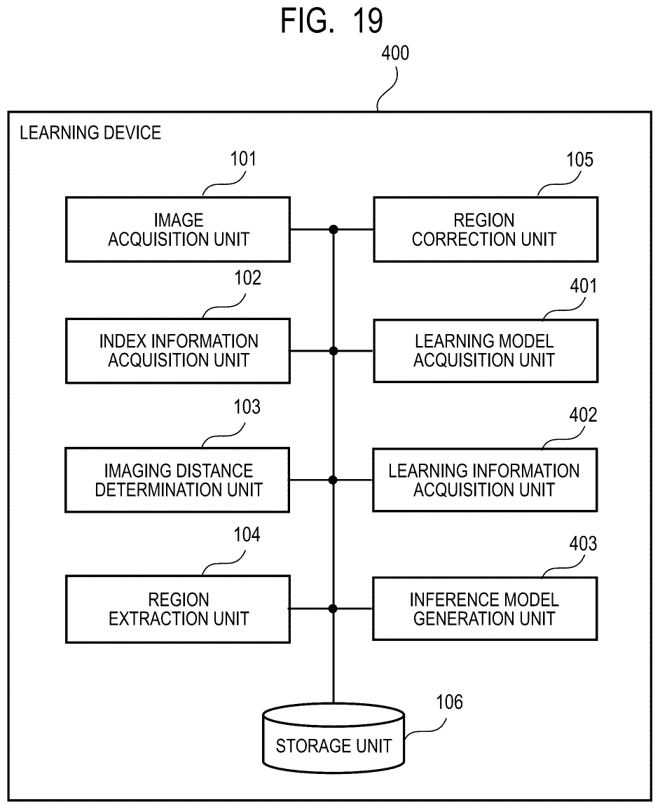

FIG. 19 shows a configuration diagram of a learning device that is capable of executing a production method for an inference model according to the present embodiment.

A learning device 400 according to the present embodiment further includes a learning model acquisition unit 401, a learning information acquisition unit 402, and an inference model generation unit 403, in addition to the constituent elements which are the same as those of the information processing system 100 according to the first embodiment. Functions of the learning model acquisition unit 401, the learning information acquisition unit 402, and the inference model generation unit 403 can be realized, for example, by the CPU 121 provided in the hardware configuration illustrated in FIG. 2.

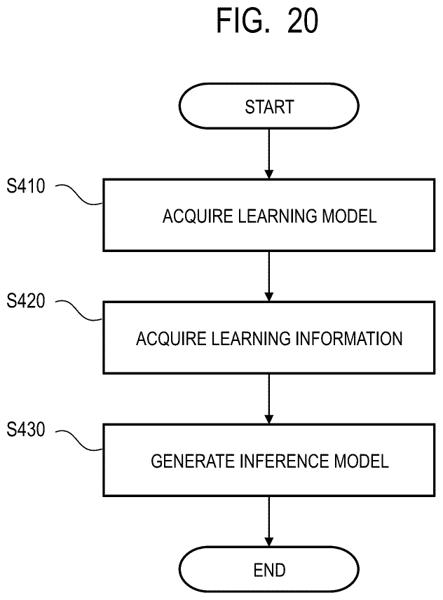

FIG. 20 shows a flow chart of a production method for an inference model according to the fourth embodiment executed by the learning device 400.

First, in a learning model acquisition step of Step S410, the learning model acquisition unit acquires a learning model to be used for production of an inference model.

As a learning model used for production of the inference model, algorithms of machine learning that are commonly used in the field of machine learning can be used. For example, algorithms such as Support Vector Machine (SVM), Random Forest, and Convolutional Neural Network (CNN) may be used. In the following, an example of producing an inference model by using the CNN is described.

Next, in a learning information acquisition step of Step S420, the learning information acquisition unit 402 acquires learning information to be used for learning of the learning model acquired in Step S410. As described in the third embodiment, the learning information used for the learning of the learning model is a combination of a plurality of reference images having pieces of imaging information that are different from each other and the calibration information.

The learning information acquired by the learning information acquisition unit 402 can be created in advance according to the first embodiment by the image acquisition unit 101, the index information acquisition unit 102, the imaging distance determination unit 103, the region extraction unit 104, and the region correction unit 105 and then stored in the storage unit 106. Alternatively, the learning information may be created in advance by using a device that is different from the learning device 400 and corresponds to the information processing system 100 according to the first embodiment and acquired from the different device by the learning information acquisition unit 402. In this case, the learning device 400 is not required to include the image acquisition unit 101, the index information acquisition unit 102, the imaging distance determination unit 103, the region extraction unit 104, and the region correction unit 105.

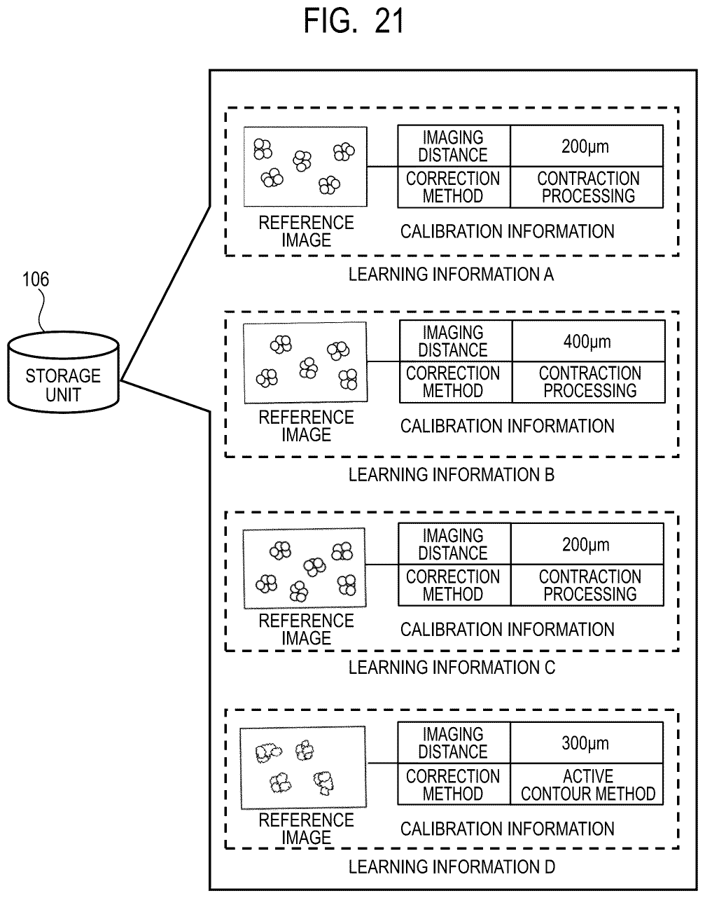

The learning information acquisition unit 402 associates the defocused image as the reference image and the calibration information and stores the resultant in the storage unit 106. FIG. 21 shows an example of reference images (defocused images) and pieces of calibration information stored in the storage unit 106.

Next, in an inference model generation step of Step S430, the inference model generation unit 403 causes the learning model to learn by using the reference images (defocused images) and the pieces of calibration information stored in the storage unit 106.

Specifically, first, a dataset to be used for learning of an image classification model is created. The dataset in the image classification includes images each having a ground truth label that serves as a supervisor.

Next, learning of the learning model is performed by using the created dataset. In a neural network like the CNN, learning is performed through the error back propagation method. The learning model by the neural network has a layered structure including an input layer, an intermediate layer, and an output layer, as well as parameters such as weights and biases given at the time of propagation of data through the layers. In the error back propagation method, the parameters are updated while error information given at the time of forward propagation of freely-selected data in the dataset from the input layer to the intermediate layer and then to the output layer is reversely propagated from the intermediate layer closer to the output layer to the input layer side. Here, the error information can be the square sum error or cross-entropy error, and the update (optimization) of the parameters can be performed by using methods such as SGD and Adam. The parameters are optimized by repeatedly performing update of the parameters by the error back propagation method by using the images of the dataset.

In the above, it is preferred that a sufficient number of images for learning of the network be provided for each of the labels. Thus, whether or not the images are to be used for learning of the learning model may be judged in accordance with the number of images in the dataset. For example, when a hundred reference images are provided for one label, the images may be used for the learning of the learning model.

In the inference model generation step, it is possible to cause the learning model to learn such that, when an image subject to the image analysis is input, the similarity with respect to the label corresponding to the calibration information included in the learning information is output.

In the manner described above, the inference model used in the third embodiment can be produced.

The information of the produced inference model can be stored in the storage unit 106. In the case of the inference model by the CNN, pieces of information of the layered structure of the input layer, the intermediate layer, and the output layer of the neural network as well as parameters such as the weight and bias are stored in the storage unit 106.

### Other Embodiments

In each embodiment and modification examples thereof described above, the information processing system (cell image analysis device) may include, for example, an imaging device for capturing a plurality of images acquired in the image acquisition step.

Further, the present disclosure is also realized by executing the following processing. Specifically, software (program) for realizing the functions of the above-mentioned embodiments by causing a computer (or CPU, MPU, or the like) to execute the software (program) is supplied to a system or an apparatus via a network or various kinds of storage media. Then, the computer (or CPU, MPU, or the like) of the system or the apparatus reads out the program to execute the processing. Further, the present disclosure may be realized by, for example, a circuit (for example, ASIC) that realizes one or more of the functions.

The above-mentioned embodiments merely describe specific examples in carrying out the present disclosure, and are not to be construed as limiting the technical scope of the present disclosure in any way. That is, the present disclosure can be implemented in various forms without departing from the technical idea or the main features of the present disclosure. It should be understood that, for example, an embodiment in which a part of a configuration of any one of the embodiments is added to another embodiment, or an embodiment in which a part of a configuration of any one of the embodiments is replaced by a part of a configuration of another embodiment is also an embodiment to which the present disclosure may be applied.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, there is provided a cell image analysis method that enables determination of an area of a cell region accurately in a simple observation in a bright field.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-006182, filed Jan. 18, 2023, which is hereby incorporated by reference herein in its entirety.

What is claimed is:

1. A cell image analysis method comprising:
an image acquisition step of acquiring a plurality of images of the cell captured at a plurality of imaging distances that are different from each other in a bright field, the imaging distance being relative distance in imaging a cell using an imaging device between an object subjected to imaging including the cell and a position of focus of an optical system of the imaging device;
an index information acquisition step of acquiring index information that is information regarding an index for evaluating a difference between the plurality of images acquired in the image acquisition step;
an imaging distance determination step of determining such an imaging distance that a rate of a change in the index information with respect to a change in the imaging distance is equal to or less than a predetermined threshold value;
a region extraction step of extracting a cell region included in an image captured at the imaging distance determined in the imaging distance determination step; and
a region correction step of performing correction on the cell region extracted in the region extraction step.

2. The cell image analysis method according to claim 1,
wherein the index information acquisition step includes determining a cell-containing region for each of the plurality of images acquired in the image acquisition step and extracting the cell region from the cell-containing region, and
wherein the index information is an area of the cell region.

3. The cell image analysis method according to claim 1, wherein the index information acquisition step includes setting a rectangular region as a cell-containing region, the rectangular region including the cell region for each of the plurality of images.

4. The cell image analysis method according to claim 3, wherein the index information acquisition step includes setting two or more rectangular regions that are different from each other for each of the plurality of images.

5. The cell image analysis method according to claim 4, wherein the imaging distance determination step includes calculating at least one value selected from a mean value, a median value, and a mode value of the imaging distances determined for the two or more rectangular regions.

6. The cell image analysis method according to claim 1, wherein the region correction step includes determining a correction method to be used for correction of the cell region.

7. The cell image analysis method according to claim 6, wherein the region correction step includes determining the correction method by selecting from contraction processing, a level-set method, and an active contour method.

8. The cell image analysis method according to claim 6, wherein the region correction step includes determining the correction method based on at least one of a circularity or a solidity of the cell region.

9. The cell image analysis method according to claim 1,
wherein the correction in the region correction step is performed by contraction processing, and
wherein the number of reduced pixels in the contraction processing is the number of pixels determined based on images of a dot pattern captured at the plurality of the imaging distances that are different from each other.

10. A cell image analysis method comprising:
an association information acquisition step of acquiring, when a combination of culture information of a cell and imaging conditions of the cell is imaging information, association information associating a plurality of pieces of the imaging information that are different from each other with calibration information;
an imaging information acquisition step of acquiring the imaging information for an image subjected to image analysis; and
a calibration information determination step of determining calibration information corresponding to the image subjected to image analysis based on the association information and the imaging information acquired in the imaging information acquisition step,
wherein the calibration information associated with the imaging information in the association information includes: an imaging distance determined through an image acquisition step, an index information acquisition step, and an imaging distance determination step; and a correction method for a cell region included in the image,
wherein the imaging distance is a relative distance in imaging the cell using an imaging device between an object subjected to imaging including the cell and a position of focus of an optical system of the imaging device,
wherein the image acquisition step is a step of acquiring a plurality of images of the cell captured at a plurality of the imaging distances that are different from each other in a bright field,
wherein the index information acquisition step is a step of acquiring index information that is information regarding an index for evaluating a difference between the plurality of images acquired in the image acquisition step, and
wherein the imaging distance determination step is a step of determining, for each of the plurality of images, such an imaging distance that a rate of a change in the index information with respect to a change in the imaging distance is equal to or less than a predetermined threshold value.

11. A cell image analysis method comprising:
an inference model acquisition step of acquiring, when a combination of culture information of a cell and imaging conditions of the cell is imaging information, and when an image of the cell captured with the imaging conditions is a reference image, an inference model that has learned by using a plurality of the reference images that are different from each other in the imaging information and calibration information; and
a calibration information determination step of determining calibration information used for image analysis by using the inference model for an image subjected to the image analysis,
wherein the calibration information used for learning by the inference model acquired in the inference model acquisition step includes an imaging distance determined through an image acquisition step, an index information acquisition step, and an imaging distance determination step and a correction method for a cell region included in the image,
wherein the imaging distance is a relative distance in imaging the cell using an imaging device between an object subjected to imaging including the cell and a position of focus of an optical system of the imaging device,
wherein the image acquisition step is a step of acquiring a plurality of images of the cell captured at a plurality of the imaging distances that are different from each other in a bright field,
wherein the index information acquisition step is a step of acquiring index information that is information regarding an index for evaluating a difference between the plurality of images acquired in the image acquisition step, and
wherein the imaging distance determination step is a step of determining, for each of the plurality of images, such an imaging distance that a rate of a change in the index information with respect to a change in the imaging distance is equal to or less than a predetermined threshold value.

12. The cell image analysis method according to claim 11, wherein the calibration information determination step includes acquiring a similarity with respect to a label corresponding to the calibration information for the image subjected to the image analysis.

13. The cell image analysis method according to claim 12, wherein the calibration information determination step includes determining, when the similarity is less than a predetermined threshold value, an imaging distance through the image acquisition step, the index information acquisition step, and the imaging distance determination step for the image subjected to the image analysis.

14. The cell image analysis method according to claim 13, further comprising a model updating step of updating, when the similarity is less than the predetermined threshold value, the inference model by using a result of determining the imaging distance through the image acquisition step, the index information acquisition step, and the imaging distance determination step for the image subjected to the image analysis.

15. A non-transitory storage medium having stored thereon a program for causing a computer to execute the cell image analysis method of claim 1.

16. A production method for an inference model comprising training a learning model such that, when a combination of culture information of a cell and imaging conditions of the cell is imaging information and an image of the cell captured with the imaging conditions by using an imaging device in a bright field is a reference image, through use of a plurality of the reference images that are different from each other in the imaging information and calibration information, a similarity with respect to a label corresponding to the calibration information is output when an image subjected to image analysis is input,
wherein the calibration information used for learning by the learning model includes an imaging distance determined through an image acquisition step, an index information acquisition step, and an imaging distance determination step and a correction method for a cell region included in the image,
wherein the imaging distance is a relative distance in imaging the cell using an imaging device between an object subjected to imaging including the cell and a position of focus of an optical system of the imaging device,
wherein the image acquisition step is a step of acquiring a plurality of images of the cell captured at a plurality of the imaging distances that are different from each other in a bright field,
wherein the index information acquisition step is a step of acquiring index information that is information regarding an index for evaluating a difference between the plurality of images acquired in the image acquisition step, and
wherein the imaging distance determination step is a step of determining, for each of the plurality of images, such an imaging distance that a rate of a change in the index information with respect to a change in the imaging distance is equal to or less than a predetermined threshold value.

17. A cell image analysis device comprising:
an image acquisition unit configured to acquire a plurality of images of the cell captured at a plurality of imaging distances that are different from each other in a bright field, the imaging distance being relative distance in imaging a cell using an imaging device between an object subjected to imaging including the cell and a position of focus of an optical system of the imaging device;
an index information acquisition unit configured to acquire index information that is information regarding an index for evaluating a difference between the plurality of images acquired by the image acquisition unit;
an imaging distance determination unit configured to determine such an imaging distance that a rate of a change in the index information with respect to a change in the imaging distance is equal to or less than a predetermined threshold value;
a region extraction unit configured to extract a cell region included in an image captured at the imaging distance determined by the imaging distance determination unit; and
a region correction unit configured to perform correction on the cell region extracted by the region extraction unit.

18. The cell image analysis device according to claim 17, further comprising an imaging device configured to capture the plurality of images.
